(19) United States
(12) Patent Application Publication
(10) Pub. No.: US 2008/0309744 A1
(43) Pub. Date: Dec. 18, 2008

(54) LIQUID-EJECTING HEAD

(75) Inventors: Kayo Mukai, Nagareyama-shi (JP); Toshio Kashino, Fujisawa-shi (JP); Teruo Tazunoki, Beppu-shi (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Misato-shi (JP)

(21) Appl. No.: 12/137,180

(22) Filed: Jun. 11, 2008

(30) Foreign Application Priority Data
Jun. 14, 2007 (JP) 2007-157589

(51) Int. Cl. B41J 2/19

(52) U.S. Cl. 347/92

(57) ABSTRACT

A liquid-ejecting head is provided whereby it is possible to eject both a main droplet and a satellite in the desired ejection direction, and furthermore, wherein no bias exists in the lifetimes of the heaters of a tip A and a tip B. In order to do so, a stopper is formed inside the ejection nozzle, the stopper limiting the movement of movable valves during bubble formation.

### BACKGROUND OF THE INVENTION

1. Field of the Invention

The present invention relates to a liquid-ejecting head that conducts printing onto a print medium by ejecting a liquid such as ink.

2. Description of the Related Art

Printing devices using the inkjet method to print by applying minute droplets of liquids such as ink to a print medium (also referred to hereinafter as inkjet printing devices) have several merits: such devices have low running costs, print very quietly, and by using ink of a plurality of colors, color printing can be conducted comparatively easily. Liquid-ejecting heads used in such inkjet devices are known wherein ejection droplets are formed and ejected using a variety of methods. Among these, there is a method known as the bubble jet method, wherein a thermoelectric conversion element (also referred to hereinafter as a heater) is used as the energy element for ejecting a droplet. In the bubble jet method, it is relatively easy to densely arrange elements, and for this reason the bubble jet method is advantageous for conducting high-resolution printing.

Japanese Patent Laid-Open No. 2000-062179 proposes such a liquid-ejecting head that is provided with a movable member inside the liquid channel (also referred to hereinafter as the nozzle). A liquid-ejecting head provided with such a movable member efficiently guides air bubbles formed by the thermoelectric conversion element in the direction of the ejection outlet, while using the movable member to control bubble growth. In so doing, irregularity in ejected droplet quantity is reduced, and ejection speed is stabilized.

Furthermore, in recent years there has been demand for increased printing speed. In liquid-ejecting heads whose aim is high-speed printing, there is demand for high ejection frequency response, wherein it is possible to continuously conduct a series of operations (i.e., the application of energy to the ejection energy generating element, the propagation of pressure to the liquid within the nozzle, and the ejection of the liquid) stably and at high speed.

Additionally, with regard to industrial inkjet printing devices in particular, demand is rising for the ability to print using special inks having properties suitable for respective print media in order to thereby print on a variety of print media. Due to these inks having characteristics such as higher viscosities compared to conventional inks, there have been cases wherein stable ejection cannot be conducted, even with a liquid-ejecting head provided with a movable valve.

Consequently, a liquid-ejecting head such as that disclosed in Japanese Patent Laid-Open No. 10-337869 is known, being provided with energy-efficient ejection and high-speed refill capability. The liquid-ejecting head was obtained by investigating the shape of the nozzle in the vicinity of the ejection energy generating element in order to stably eject even special inks. As shown in FIG. 8A, to be hereinafter described, Japanese Patent Laid-Open No. 10-337869 discloses technology wherein, in a liquid-ejecting head having two movable valves 6 and two heaters 2, the heaters 2 are provided in the liquid flow channel 11 in an overlapping manner so as to face each other, while the two movable valves 6 are displaced so as to approach each other when moved to eject liquid.

By using this method, it becomes possible to increase the ejection energy, while additionally improving the refill speed. In addition, by including a step accompanying bubble formation and growth wherein at least one portion of the two movable valves mutually contact each other, ejection quantities are stabilized.

FIGS. 8A to 8F are lateral cross-section views showing, in a stepwise manner, ejection states for a liquid-ejecting head provided with the facing movable valves of the related art. The liquid-ejecting head is symmetric up-and -down about the ejection outlet centerline θ, and for the sake of convenience in explanation thereof, the upper portion above the ejection outlet centerline θ is referred to as tip A, while the lower portion is referred to as tip B. Hereinafter, the steps in ejection process will be described in order.

FIG. 8A shows the state before heating is conducted, wherein current is not flowing to the heaters 2. FIGS. 8B and 8C show the states wherein bubbles are formed accompanying film boiling, occurring as a result of energy being input into the heaters 2 and the liquid being heated. At this point, the movable valves 6 are displaced so as to guide the propagation direction of the pressure due to bubble formation along the ejection direction, the displacement taking the ejection outlet side of a valve support member 10 as a fulcrum.

FIGS. 8D and 8E show the states wherein heating of the liquid by the heaters 2 has been terminated and the bubbles are in the process of contracting. As the bubbles contract, liquid near the ejection outlet 2 is drawn into the ejection nozzle 11. Since inertial force is working in the ejection direction at the tip of the liquid column, the liquid column becomes separated from the liquid within the ejection nozzle 11. Due to surface tension, the separated liquid column then forms a main droplet and a satellite, which then fly to the print medium. Subsequently, in FIG. 8F, the liquid-ejecting head returns to the state shown in FIG. 8A.

However, when the movable valves 6 are displaced, a discrepancy in the size of the bubbles formed at the tip A and the tip B occurs as shown in FIG. 8C if, for example, the movable valve of tip A bends less readily than the movable valve of tip B (i.e., the movable valve 6 of tip A is thicker than the movable valve of tip B, or, there is a difference in the thicknesses of the bending portions thereof). When such a phenomenon occurs, since the bubble on the tip B side is large, the movable valve 6 on the tip B side bends considerably, thereby worsening the balance between the pressure propagation direction at the tip A and the pressure propagation direction at the tip B. In other words, the pressure propagation directions of the tip A and the tip B stop being axisymmetrical with respect to the centerline θ of the ejection outlet.

Furthermore, another problem occurs when ejecting liquid. Although the main droplet is ejected in the desired direction due to having a relatively larger mass, the satellite, being influenced by the oblique pressure, flies in a direction somewhat skewed from the direction in which the main droplet was ejected. Consequently, discrepancies may occur between the ejection directions of the main droplet and the satellite. When such a discrepancy occurs between the ejection directions of the main droplet and the satellite, print quality is lowered because of the satellite.

In this way, even if movable valves provided within the liquid channel are disposed facing each other, the amounts by which the movable valves bend will differ if there is a slight irregularity (of thickness or shape) in the construction of the facing movable valves. As a result, the shapes and sizes of the bubbles may be different because of a discrepancy in the movable distance of the movable valves, and thus the ejection directions of the liquid droplets may be skewed from the desired direction. In addition, when breaking the bubbles formed at the facing regions of bubble formation, the merged bubble formed from the temporarily joining of two bubbles is divided. If the merged bubble is not divided evenly with respect to the facing ejection energy generating elements, the cavitation formed by defoaming will have differing degrees of effect on the ejection energy generating elements. As a result, there is the possibility of a difference in the lifetimes of the facing ejection energy generating elements.

As described in the foregoing, even with a liquid-ejecting head having a construction wherein both bubble formation regions and movable members are provided facing each other, achieving the original goal of stable ejection stably and over long periods has been difficult.

### SUMMARY OF THE INVENTION

The present invention provides a liquid-ejecting head wherein both a main droplet and a satellite are ejected in the desired ejection direction, and furthermore, wherein there is no bias in the lifetimes of the heaters of the tip A and the tip B.

An embodiment in accordance with the present invention is a liquid-ejecting head capable of ejecting liquid by using two bubbles formed by first heating and foaming the liquid using two heaters provided in a facing manner inside the nozzle, the liquid-ejecting head furthermore having two plate movable valves that are displaced upon receiving pressure due to the formed bubbles. In the interior of the nozzle of the liquid-ejecting head, a stopper is provided that limits the movement of the two movable valves.

According to the present invention, by providing within the interior of the nozzle a stopper that limits the movement of the two movable valves, it becomes possible to eject both the main droplet and the satellite in the desired ejection direction, and furthermore, bias in the respective lifetimes of the heaters is eliminated.

Further features of the present invention will become apparent from the following description of exemplary embodiments (with reference to the attached drawings).

### BRIEF DESCRIPTION OF THE DRAWINGS

FIG. 1 is a diagrammatic front view showing the interior construction of one embodiment of a liquid-ejecting device provided with a liquid-ejecting head of the present invention;

FIG. 2 is a perspective view showing a liquid-ejecting head of the present invention;

FIG. 3 is a cross-sectional perspective view of the vicinity of the nozzle in a liquid-ejecting head of the present invention;

FIG. 4A is a front view of liquid-ejecting heads during the manufacturing process thereof;

FIG. 4B is a front view of liquid-ejecting heads during the manufacturing process thereof;

FIG. 4C is a front view of liquid-ejecting heads during the manufacturing process thereof;

FIG. 4D is a front view of liquid-ejecting heads during the manufacturing process thereof;

FIG. 4E is a front view of liquid-ejecting heads during the manufacturing process thereof;

FIG. 4F is a front view of liquid-ejecting heads during the manufacturing process thereof;

FIG. 4G is a front view of liquid-ejecting heads during the manufacturing process thereof;

FIG. 4H is a front view of liquid-ejecting heads during the manufacturing process thereof;

FIG. 5A is a lateral view of a liquid-ejecting head during the manufacturing process thereof;

FIG. 5B is a lateral view of a liquid-ejecting head during the manufacturing process thereof;

FIG. 5C is a lateral view of a liquid-ejecting head during the manufacturing process thereof;

FIG. 5D is a lateral view of a liquid-ejecting head during the manufacturing process thereof;

FIG. 5E is a lateral view of a liquid-ejecting head during the manufacturing process thereof;

FIG. 5F is a lateral view of a liquid-ejecting head during the manufacturing process thereof:

FIG. 5G is a lateral view of a liquid-ejecting head during the manufacturing process thereof;

FIG. 5H is a lateral view of a liquid-ejecting head during the manufacturing process thereof;

FIG. 6A is a lateral cross-sectional view showing, in a stepwise manner, the state of ejection in the liquid-ejecting head of the primary embodiment;

FIG. 6B is a lateral cross-sectional view showing, in a stepwise manner, the state of ejection in the liquid-ejecting head of the primary embodiment;

FIG. 6C is a lateral cross-sectional view showing, in a stepwise manner, the state of ejection in the liquid-ejecting head of the primary embodiment;

FIG. 6D is a lateral cross-sectional view showing, in a stepwise manner, the state of ejection in the liquid-ejecting head of the primary embodiment;

FIG. 6E is a lateral cross-sectional view showing, in a stepwise manner, the state of ejection in the liquid-ejecting head of the primary embodiment;

FIG. 6F is a lateral cross-sectional view showing, in a stepwise manner, the state of ejection in the liquid-ejecting head of the primary embodiment;

FIG. 7A is a lateral cross-sectional view showing, in a stepwise manner, the state of the ejection of liquid by a liquid-ejecting head of another embodiment;

FIG. 7B is a lateral cross-sectional view showing, in a stepwise manner, the state of the ejection of liquid by a liquid-ejecting head of another embodiment;

FIG. 7C is a lateral cross-sectional view showing, in a stepwise manner, the state of the ejection of liquid by a liquid-ejecting head of another embodiment;

FIG. 7D is a lateral cross-sectional view showing, in a stepwise manner, the state of the ejection of liquid by a liquid-ejecting head of another embodiment;

FIG. 7E is a lateral cross-sectional view showing, in a stepwise manner, the state of the ejection of liquid by a liquid-ejecting head of another embodiment;

FIG. 7F is a lateral cross-sectional view showing, in a stepwise manner, the state of the ejection of liquid by a liquid-ejecting head of another embodiment;

FIG. 8A is a lateral cross-sectional view showing, in a stepwise manner, the state of ejection by a liquid-ejecting head provided with facing movable valves of the related art;

FIG. 8B is a lateral cross-sectional view showing, in a stepwise manner, the state of ejection by a liquid-ejecting head provided with facing movable valves of the related art;

FIG. 8C is a lateral cross-sectional view showing, in a stepwise manner, the state of ejection by a liquid-ejecting head provided with facing movable valves of the related art;

FIG. 8D is a lateral cross-sectional view showing, in a stepwise manner, the state of ejection by a liquid-ejecting head provided with facing movable valves of the related art;

FIG. 8E is a lateral cross-sectional view showing, in a stepwise manner, the state of ejection by a liquid-ejecting head provided with facing movable valves of the related art; and

FIG. 8F is a lateral cross-sectional view showing, in a stepwise manner, the state of ejection by a liquid-ejecting head provided with facing movable valves of the related art.

### DESCRIPTION OF THE EMBODIMENTS

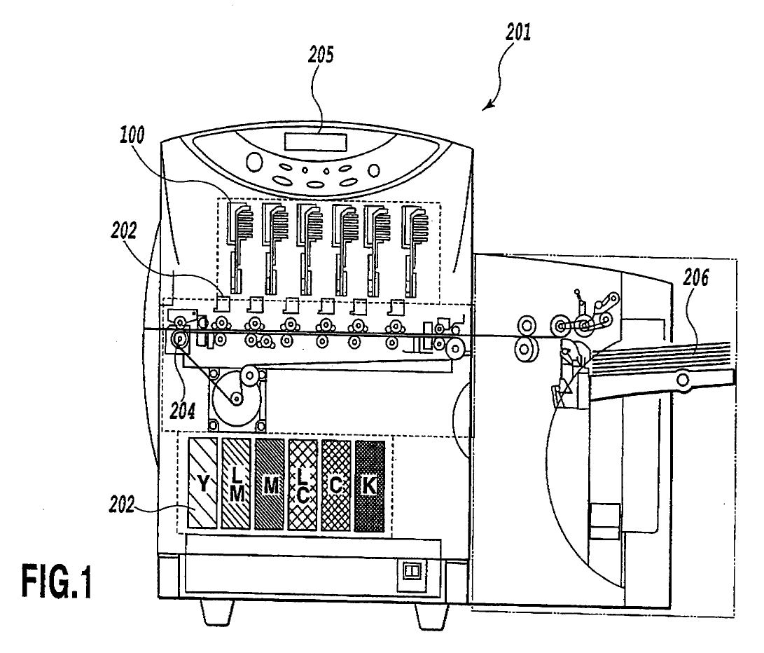

Hereinafter, the present invention will be described with reference to the accompanying drawings. FIG. 1 is a diagrammatic front view showing the interior construction of one embodiment of a liquid-ejecting device 201 provided with a liquid-ejecting head of the present invention. The liquid-ejecting device 201 includes a plurality of liquid-ejecting heads 100, recovery units 202 individually provided for each liquid-ejecting head, cartridges 203, a transport unit 204, an operational panel unit 205, and a paper feed unit 206.

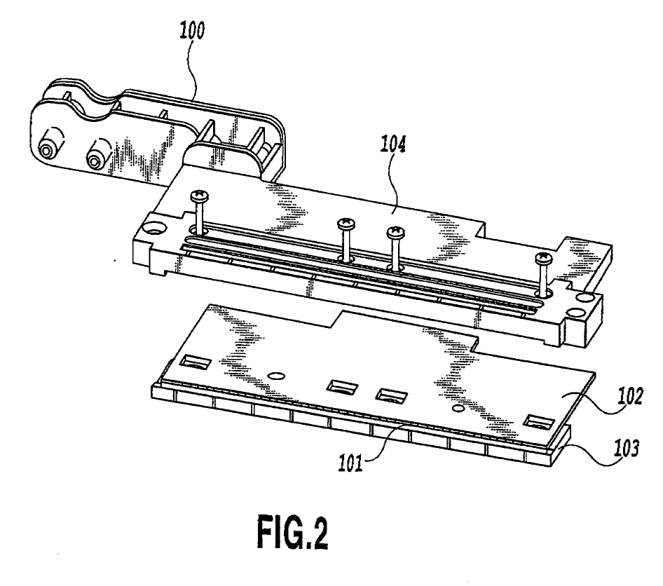

FIG. 2 is a perspective view showing a liquid-ejecting head of the present invention. An ejection element 101, being provided with an ejection energy generating element, nozzle, and ejection outlet, is disposed upon a ceramic plate 103 along with a circuit board 102. A common liquid reservoir 12, to be hereinafter described, is provided within the ejection element 101 and connected to a flow channel provided in the interior of a flow channel forming member 104. Furthermore, the common liquid reservoir 12 is supplied with a liquid (ink, for example) from an ink tank connected to the ink supply opening of the flow channel forming member 104.

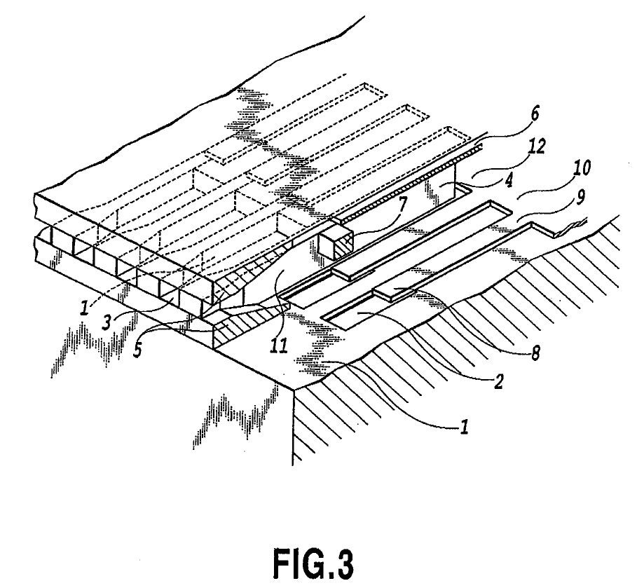

FIG. 3 is a cross-sectional perspective view of the vicinity of the nozzle in a liquid-ejecting head of the present invention. A plurality of heaters 2 for heating and foaming ink are provided upon a heater board 1, and in the present embodiment, two heater boards 1 are disposed so as to face each other. In each heater 2 a resistive element such as tantalum nitride is used, having a thickness of 0.01 μm to 0.5 μm and a sheet resistance of 10 O to 300 O per unit square. Connected to each heater 2 is an electrode (not shown in the drawings) for providing current and made of aluminum or similar material. One end of the electrode is also connected to a switching transistor (not shown in the drawings) for regulating the amount of current fed to a respective heater 2. The driving of the switching transistor is controlled by an IC formed from circuits of control gate elements or similar components, such that the IC drives the switching transistor in a set pattern according to a received signal external to the head.

Plate, movable valves 6 are disposed corresponding to each heater 2. The free end 8 of each movable valve 6 faces in the direction of the ejection outlet 3, while the fulcrum 9 of each movable valve 6 is provided positioned inside the common liquid reservoir 12. The fulcrum 9 is affixed to a valve support member 10, the valve support member 10 being mounted upon a valve base (not shown in the drawings) formed on the heater board 1.

Meanwhile, ejection nozzles 11 are formed corresponding to each heater of the plurality of heaters 2, with heaters (not shown in the drawings) being provided on the heater board 1 in the upper part of the drawing so as to face the heaters 2 provided on the heater board 1 in the lower part of the drawing. Each ejection nozzle 11 is coupled to a respective ejection outlet 3 as well as the common liquid reservoir 12. By disposing the ejection nozzles 11 such that the mounting surfaces of the respective heaters 2 on the two heater boards 1 face each other, a ceiling surface and a floor surface are formed. The two surfaces are taken to be the nozzle wall 4, forming a tubular shape.

In the space between the free ends 8 of respective movable valves 6 provided facing each other, a valve stopper 7 is provided joined to the nozzle wall 4. The position and height of the stopper 7 is decided such that the distance to each of the facing movable valves 6 is identical. In the present embodiment, the valve stopper 7, as well as the nozzle wall 4 and the nozzle ridge 5 that forms the periphery of the ejection outlet 3, are formed from photosensitive resin.

Ink supplied to a respective ejection nozzle 11 from the common liquid reservoir 12 is heated by the respective heaters 2 disposed at predetermined positions within the ejection nozzle 11, thereby forming bubbles. As the ink within the ejection nozzle 11 begins to move as the bubbles form, the movable valves 6 are displaced at the same time, thereby regulating the flow of the ink. Subsequently, ink is ejected from the ejection outlet 3.

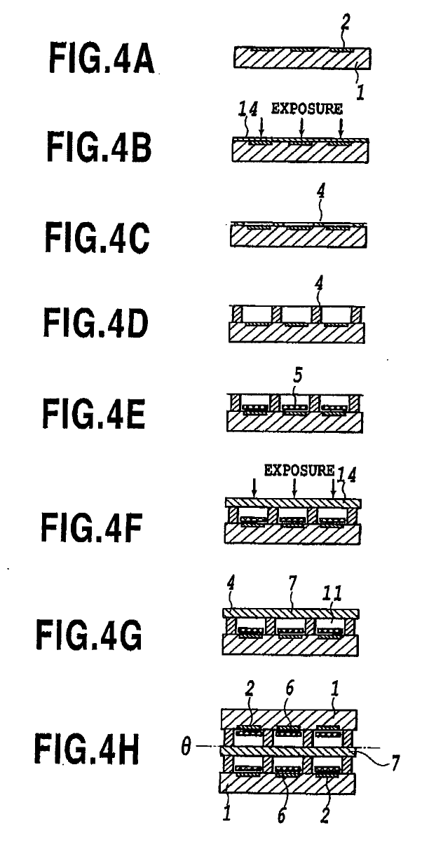

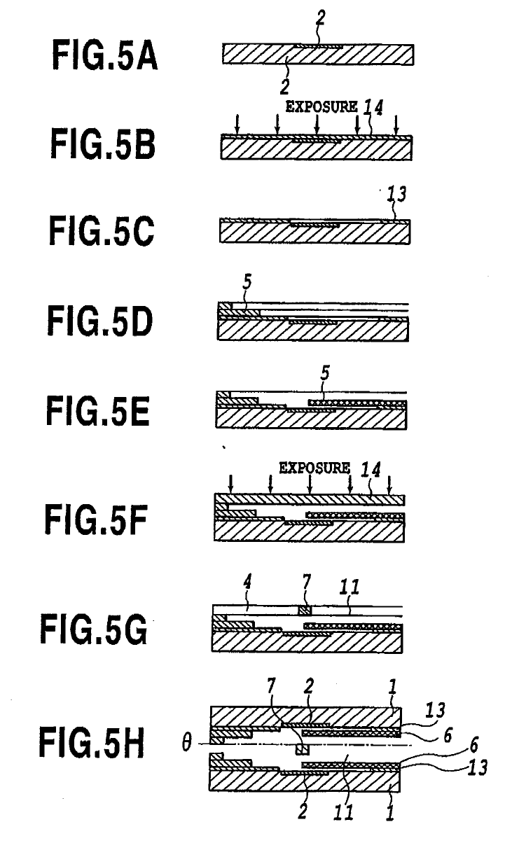

Next, a method of manufacturing the liquid-ejecting head of the present invention will be described using FIGS. 4 and 5. In the liquid-ejecting head of the present embodiment, two heater boards 1 (hereinafter, the respective heater boards 1 will be referred to as tip A and tip B) having heaters 2 are joined so as to be mutually facing each other. The formation of the two facing heater boards 1 is conducted using the same steps, up to an intermediate step. Consequently, first the identical steps up to the intermediate step will be described below.

FIGS. 4A through 4H are cross-sectional front views showing the process order in the manufacture of the liquid-ejecting head. FIGS. 5A through 5H are cross-sectional lateral views of the same, each corresponding to a respective FIG. 4A through 4H. At this point, the process from FIG. 4A to 4E will first be described. In the step in FIG. 4A, the heaters 2 are formed upon the heater board 1. In FIG. 4B, a resinous film 14 sensitive to ultraviolet light is laminated upon the heater board 1 provided with heaters 2, and then exposed ultraviolet light via a photomask. In so doing, as shown in FIG. 4C, a portion of the nozzle wall 4, and subsequently the base 13 which acts as the movable valve base, are formed. Furthermore, by lamination of resinous film sensitive to ultraviolet light and exposure of ultraviolet light, the bumps of the nozzle ridges 5 and the nozzle walls 4 are formed, as shown In FIGS. 4D and 4E. Subsequently, the nozzle ridges 5, valve bases 13, and nozzle walls 4 formed by the above method are developed using a developer made from a mixture of xylene and butyl cellosolve acetate or similar chemicals. The unexposed portions thereof are melted, exposed, and hardened. After forming the nozzle walls 4 in this way, the movable valves 6 are affixed to the valve bases 13, as shown in FIG. 4E.

The process up to this point are similar for both tip A and tip B. Hereinafter, the steps for tip A only will be described. FIGS. 4F and 4G are steps for tip A only, and the formation of tip B lacks any such corresponding steps. In FIG. 4F, a resinous film sensitive to ultraviolet light is laminated on the nozzle walls 4 of the tip A formed in FIG. 4E, and then ultraviolet exposure is conducted. Subsequently, the tip A is developed using a developer made from a mixture of xylene and butyl cellosolve acetate or similar chemicals. The unexposed portions thereof are melted, exposed, and hardened. As a result, the nozzle wall 4 and the valve stopper 7 as shown in FIG. 4G are formed. The valve stopper 7 is configured having a gap between the bottom surface thereof and the free-ends 8 of the movable valves 6, while both ends of the valve stopper 7 are connected to the nozzle wall (side walls).

In this way, after forming the stopper 7 on the tip A, the tip A as shown In FIG. 4H is joined with the tip B formed via the steps up to FIG. 4E. When joining the tip A and the tip B, a photosensitive, resinous film is laminated on the surface of the nozzle walls 4 of the tip B, and subsequently, the centers of the heaters 2 of the tip A and the centers of the heaters 2 of the tip B are respectively joined so as to be precisely positioned. By subsequently heating the tips in the joined state, the photosensitive, resinous film hardens, and thereby the tip A and the tip B are completely bonded together.

As a result of the above process, the ejection element 101 of a liquid-ejecting head is completed, wherein two heaters face each other and two movable valves 6 face each other inside an ejection nozzle 11.

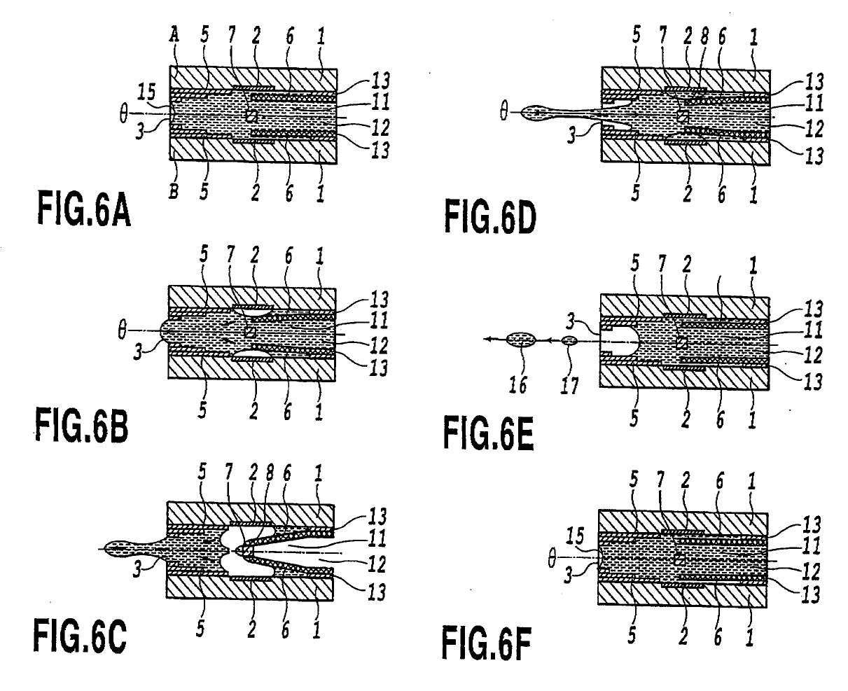

FIGS. 6A to 6F are lateral cross-sectional views showing, in a stepwise manner, states of ejection in the liquid-ejecting head of the present embodiment. Hereinafter, states of ejection in the liquid-ejecting head of the present embodiment will be described with reference to these drawings. FIG. 6A shows the state before heating is conducted, when current is not flowing to the heaters 2. Ink near the ejection outlet 3 forms a meniscus 15, and the ink being retained within the ejection nozzle 11. FIGS. 6D and 6C show the state wherein bubbles are formed accompanying film boiling, as a result of energy being input into the heaters 2 and the ink being heated. At this point, the movable valves 6 are displaced so as to guide the propagation direction of the pressure due to bubble formation along the ejection direction, the displacement taking the side of the valve support member 10 near the ejection outlet 3 as a fulcrum. Ink within the nozzle is pushed out from the ejection outlet 3 by the pressure generated by bubble formation, and an ink column is formed as the bubbles grow. In FIG. 6C, the tips in the ejection outlet direction of the movable valve 6 of the tip A and the movable valve 6 of the tip B are contacting the stopper 7. The stopper 7 is provided in a position so as to be contacting both the movable valve 6 of the tip A and the movable valve 6 of the tip B when the movable valves 6 are displaced at the time of maximal bubble formation. Furthermore, the stopper 7 is designed such that the distance from the free end 8 of a movable valve 6 to the stopper 7 is the same for both tip A and tip B when in the state where bubbles have not been formed. Consequently, the movable distances of the movable valves 6 are equal for both tip A and tip B, and the bubble sizes on the tip A side and the tip B side are also equal. Although in FIG. 6C the bubble formed on the A side of the stopper 7 is contacting the bubble formed on the B side of the stopper 7, the bubbles need not be contacting.

By providing the stopper 7 in this way, the propagation direction of the pressure generated during bubble formation becomes symmetrical on the tip A side and the tip B side about the ejection outlet centerline θ. In addition, it becomes possible to eject both a main droplet. 16 and a satellite 17 in the desired ejection direction. Moreover, since the bubble size is equal on the tip A side and the tip B side, cavitation strength is balanced between the facing heaters, thereby making it possible to equalize the lifetimes of the heaters of the tip A and the tip B.

FIGS. 6D and 6E show the state wherein heating of the ink by the heaters 2 has terminated and the bubbles are in the process of contracting. As the bubbles contract, ink near the ejection outlet 3 is drawn inside the nozzle. Since inertial force is working in the ejection direction at the tip of the ink column, the ink column becomes separated from the ink within the ejection nozzle 11. Due to surface tension, the separated ink column forms a main droplet 16 and a satellite 17, which then fly toward the print medium.

FIG. 6F shows the state after an ink droplet has been ejected, with a meniscus 15 reforming near the ejection outlet 3. By repeating the actions of FIGS. 6A to 6F, ink droplets are ejected onto media, and an Image is formed.

In this way, by forming a stopper 7 inside the ejection nozzle and limiting the movement of the movable valves 6 when ejecting liquid, the propagation direction of the pressure generated during bubble formation becomes symmetrical on the tip A side and the tip B side about the ejection outlet centerline θ. As a result, it becomes possible to eject both the main droplet 16 and the satellite 17 in the desired ejection direction. Moreover, cavitation strength is balanced between the facing heaters, thereby making it possible to equalize the lifetimes of the heaters 2 of the tip A and the tip B.

It should be appreciated that although in the present embodiment the ejection element 101 was formed by mounting the tip B on having formed the stopper 7 on the tip A, the stopper 7 is not limited to being formed on the tip A, and may also be formed on the tip B.

In addition, although In the present embodiment the ejection element 101 was formed by mounting the tip B on having formed the stopper 7 on the tip A, the ejection element 101 may also be formed such that a stopper is also formed on the tip B and then mounted onto the tip A where a stopper has also been formed.

### Other Embodiments

Hereinafter, another embodiment of the present embodiment will be described with reference to the accompanying drawings. The liquid-ejecting head of the present embodiment is nearly identical to the liquid-ejecting head of the foregoing embodiment, with only the stopper dimensions being different other features are identical to that of the foregoing embodiment, and thus description thereof will be omitted for the sake of brevity.

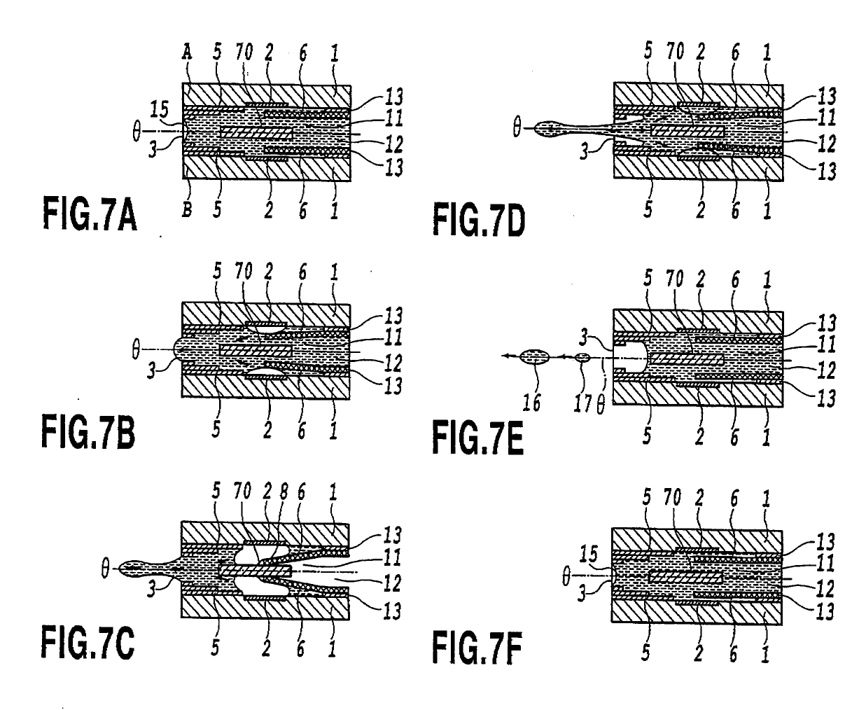

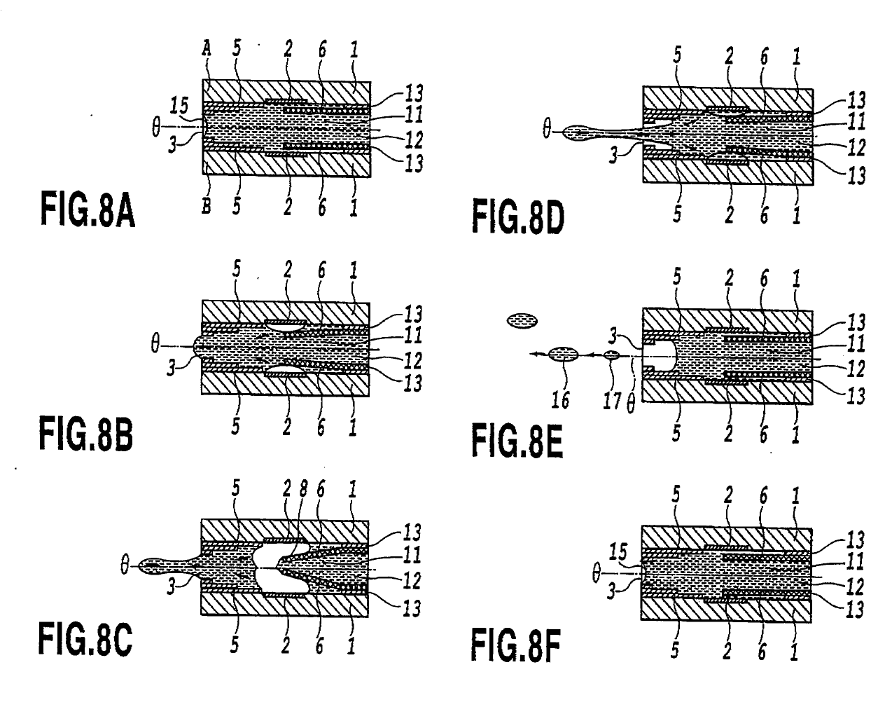

FIGS. 7A to 7F are lateral cross-sectional views showing, in a stepwise manner, the state of the ejection of liquid by a liquid-ejecting head of the present embodiment. As shown in FIGS. 7A to 7F, the stopper 70 provided in the liquid-ejecting head of the present embodiment is the same as the stopper 7 in the foregoing embodiment, except lengthened towards the ejection outlet 3 and towards the common liquid reservoir 12. The nozzle cross-section is up-and-down symmetrical about the ejection outlet centerline θ, and for the sake of convenience in the explanation thereof, the upper portion above the ejection outlet centerline θ is referred to as tip A, while the lower portion is referred to as tip B.

Except for that shown in FIGS. 7C and 7D, the present embodiment is identical to the foregoing embodiment and thus explanation thereof will be omitted for the sake of brevity. In FIG. 7C, the tip of the movable valve 6 of the tip A and tip of the movable valve 6 of the tip B are contacting the stopper 70. The stopper 70 is provided in a position so as to be contacting both the movable valve 6 of the tip A and of the tip B when the movable valves 6 are displaced at the time of maximal bubble formation. Furthermore, the stopper 70 is designed such that the distance from the free end 8 of a movable valve 6 to the stopper 70 is the same for both tip A and tip B when in the state where bubbles have not been formed. Consequently, the movable distances of the movable valves 6 are equal for both tip A and tip B, and the bubble sizes on the tip A side and the tip B side are also equal. In addition, since the stopper 70 extends in the direction of the ejection outlet 20, the bubble on the tip A side and the bubble on the tip B side do not come into contact, even at the time of maximal bubble formation. FIG. 7D shows the state wherein heating of the liquid by the heaters 2 has terminated and the bubbles are in the process of contracting. The bubbles on the tip A side and the tip B side, having achieved their maximum volume in FIG. 7C, are completely separated by the stopper 70, and thus the bubbles do not deviate to the side of one tip or the other during defoaming. Furthermore, equal amounts of liquid are drawn in on the tip A side and the tip B side, and thus ink refilling is conducted equally.

In this way, the movement of the movable valves 6 is limited by the stopper 70, and additionally, bubble growth is limited. In so doing, pressure propagation during bubble formation and the drawing-in of ink during defoaming becomes axisymmetrical on the tip A side and the tip B side about the ejection outlet centerline 9. As a result, it becomes possible to eject both the main droplet 16 and the satellite 17 in the desired ejection direction. Moreover, cavitation strength between the facing heaters becomes equal, thereby making it possible to equalize the lifetimes of the heaters of the tip A and the tip B.

It should be appreciated that while in each of the foregoing embodiments examples were described applied to the full-line type printing method, the invention is not limited thereto, and may also be applied to serial-type printing methods wherein the print head moves during printing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-157589, filed Jun. 14, 2007, which is hereby incorporated by reference herein in its entirety.

What is claimed is:

1. A liquid-ejecting head, capable of ejecting liquid by using two bubbles formed by first heating and foaming the liquid using two heaters provided in a facing manner inside the nozzle, the liquid-ejecting head furthermore having two palate movable valves that are displaced upon receiving pressure due to the formed bubbles, comprising:
a stopper, provided in the interior of the nozzle, that limits the movement of the two movable valves.

2. The liquid-ejecting head according to claim 1, wherein the stopper limits the position of the free ends of the two movable valves.

3. The liquid-ejecting head according to claim 1, wherein the respective distances between the free ends of the two movable valves and the stopper are equal.

4. The liquid-ejecting head according to claim 1, wherein the two movable valves and the two heaters that form bubbles are the same size, respectively.

5. The liquid-ejecting head according to claim 1, wherein the two movable valves contact the stopper at the time of liquid ejection.

6. The liquid-ejecting head according to claim 1, wherein the stopper is supported by the lateral walls forming the nozzle.

7. The liquid-ejecting head according to claim 1, wherein the stopper isolates the two bubbles.
